(19) United States
(12) Patent Application Publication
(10) Pub. No.: US 2011/0139191 A1
(43) Pub. Date: Jun. 16, 2011

(54) HYDRAULIC ACNE SUCTION CLEANSER

(76) Inventor: Kuei-Hsin Huang, Taipei County (TW)

(21) Appl. No.: 12/637,437

(22) Filed: Dec. 14, 2009

(51) Int. Cl. B08B 3/02

(52) U.S. Cl. 134/60

(57) ABSTRACT

A hydraulic acne suction cleanser includes a suction head, a body connecting to an end connector of a shower duct or an adapter duct of an outlet of a faucet and a connection hose communicating the suction head and the body. The body includes a pressurized chamber, a suction port, a water discharge passage and a water intake passage. The pressurized chamber communicates with exterior space of the body through the suction port. The water discharge passage and water intake passage are extended respectively to form a converging orifice and an ejection orifice surrounded by the converging orifice in the pressurized chamber, and form respectively a water outlet and a water inlet on the body. The suction port has an opening directing towards the circumference of the converging orifice. The water inlet has external threads formed on the circumference corresponding to internal threads of the end connector or adapter duct.

### FIELD OF THE INVENTION

The present invention relates to a hydraulic acne suction cleanser and particularly to a suction cleanser that generates airflow suction through water flow pressure to be used in beauty or medical treatments.

### BACKGROUND OF THE INVENTION

Suction is a commonly used conventional means in beauty and medical treatments. The suction can be generated in many ways. For instance, a cupping generates suction due to volume variation of cool and hot air, and a vacuum suction device generates suction by driving of an electric motor. They all aim to generate vacuum suction to produce local suction on human skin to achieve desired purposes, such as stimulating blood circulation, sucking acnes or the like.

Acne suction cleanser is one of widely used instruments in beauty and medical treatments. It generally has an electric motor to drive a vacuum pump to generate suction to suck acnes from the skin surface layer. The electric motor and vacuum pump are bulky, hence they usually are installed in medical clinics or beauty centers. To promote its usability, portable acne suction cleanser has been developed. It mainly is driven by a smaller motor and can be held by user's hands, thus can be used by general users at home. Because the motor in the portal acne suction cleanser is smaller, its driving power and suction often are not stronger enough. Moreover, batteries have to be replaced frequently or external electric power has to be connected when in use, extra waste of power resources occurs.

To remedy the aforesaid problems, other improvements have been proposed. For instance, R.O.C. patent No. 511508 entitled “Small-sized hydraulic suction apparatus for beauty and medical treatments” has a body installed on one end of a faucet for passing through the water flow with a housing chamber inside and a converging tilted conical surface and a flow converging portion located in the housing chamber. Water flow passes through the converging tilted conical surface to the housing chamber and flows out through the flow converging portion, and a negative pressure space is formed in the housing chamber. An opening is formed on an outer wall of the housing chamber to generate suction, thus forms the hydraulic suction apparatus. Such a structure generates the suction through water flow pressure and can be applied to an acne suction cleaner, and it is adaptable for general household use. As it employs hydraulic power to replace the electric motor, thus energy consumption can be reduced. However, it has to be directly installed on the faucet end, so that its usability is restricted. Moreover, since its connection structure is simpler, while users increasing higher water pressure to enhance the suction, this easily causes water leakage or even separation of the body and faucet due to the higher water pressure, and results in suction function loss. Hence there are still rooms for improvement on the conventional hydraulic acne suction cleanser.

### SUMMARY OF THE INVENTION

In view of the aforesaid disadvantages occurred to the conventional hydraulic acne suction cleanser, the primary object of the present invention is to provide a sturdier hydraulic acne suction cleanser, and it can be used more widely and applicable, and also provide a firmer connection and positioning structure.

The hydraulic acne suction cleanser according to the present invention has a suction head, a body connecting to an end connector of a shower duct or an adapter duct coupling on the outlet of a faucet, and a connection hose communicating with the suction head and the body. The end connector of the shower duct and the adapter duct have internal threads formed respectively on the inner circumference thereof. The body has a closed pressurized chamber inside and a suction port communicating the pressurized chamber and the exterior space of the body. The body also has a water discharge passage which has a water outlet at one end communicating to the exterior space of the body and the other end extended to form a converging orifice in the pressurized chamber. The suction port has an opening directing towards the circumference of the converging orifice. The body further has water intake passage with one end communicating to the exterior space of the body to form a water inlet and the other end extended in the pressurized chamber to become an ejection orifice surrounded by the converging orifice. The water inlet has external threads on the circumference corresponding to the internal threads of the end connector of the shower duct or the adapter duct. Thus forms the fundamental structure of the present invention. Such a structure allows water flow introduced from a water supply end passing through the water inlet, water intake passage, ejection orifice, pressurized chamber, converging orifice, water discharge passage and to be discharged through the water outlet. The suction port generates airflow and suction. The ejection orifice has a nozzle extended from the water intake passage to the pressurized chamber and an ejection duct connecting to an opening of the nozzle. The present invention also provides a fixed chain on the body to enhance usability.

By means of the structure set forth above, the present invention provides many benefits over the conventional techniques, notably:

1. The present invention employs screw fastening means to connect the water inlet and external water supply end, fastening of the hydraulic acne suction cleanser is firmer and loosening thereof caused by variations of water pressure can be prevented.

2. Because the water inlet and the external water supply end are fastened by screwing, the hydraulic acne suction cleanser of the present invention can be easily coupled with the end connector of the shower duct or the end of an external water pipe that has threads formed thereon. Thus it provides a greater applicability.

3. By providing the fixed chain, the present invention can be hung and positioned easily to improve usability and stability in varying environments.

4. With the ejection duct held in ejection orifice, the ejection orifice can withstand a greater water flow pressure and water can be ejected steadily through the ejection duct. As a result, the efficiency and strength of the suction port sucking airflow can be enhanced.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of the present invention.

FIG. 2 is an exploded view of the present invention.

FIG. 3 is a sectional view of the present invention.

FIG. 4 is a sectional view of the present invention showing airflow and water flow directions.

FIG. 5 is a schematic view of embodiment-1 of the present invention.

FIG. 6 is a schematic view of embodiment-2 of the present invention.

FIG. 7 is a schematic view of embodiment-3 of the present invention.

### DETAILED DESCRIPTION OF THE PREFERRED EMBODIMENTS

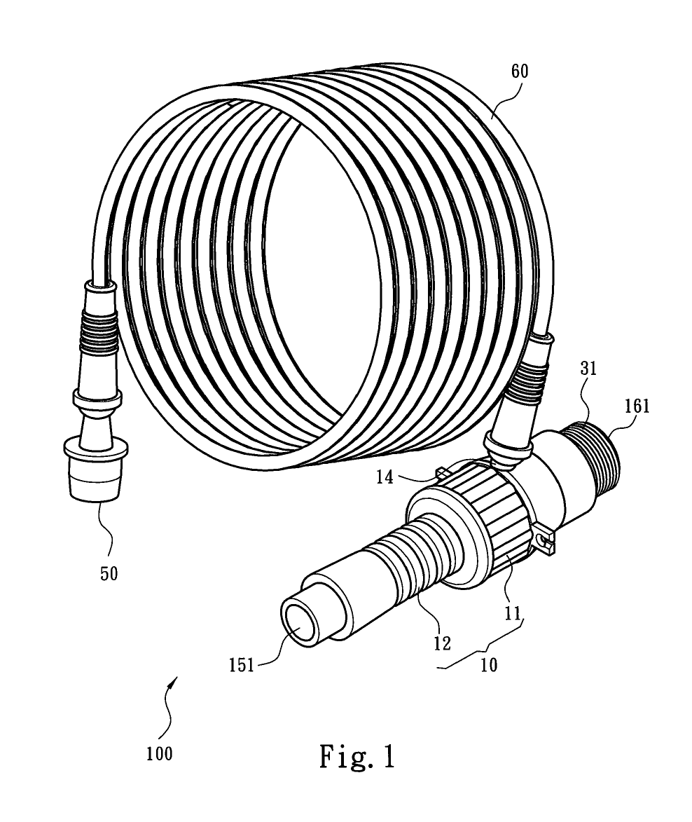

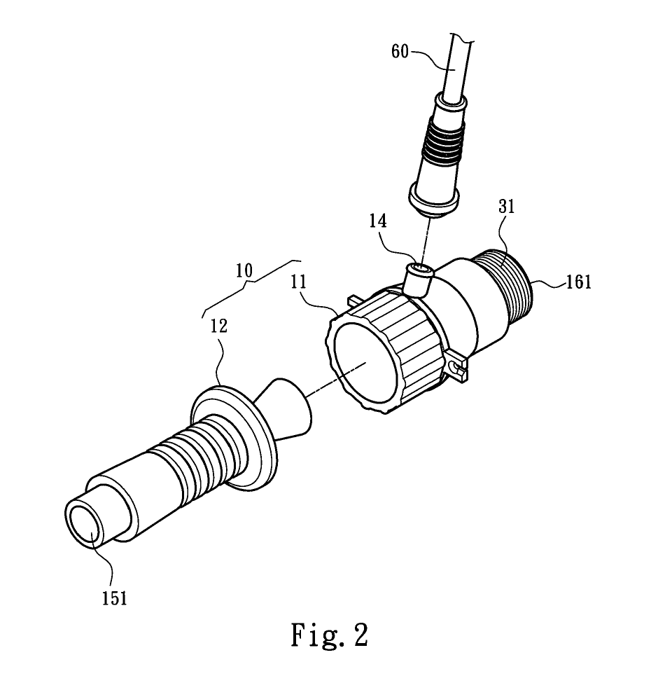

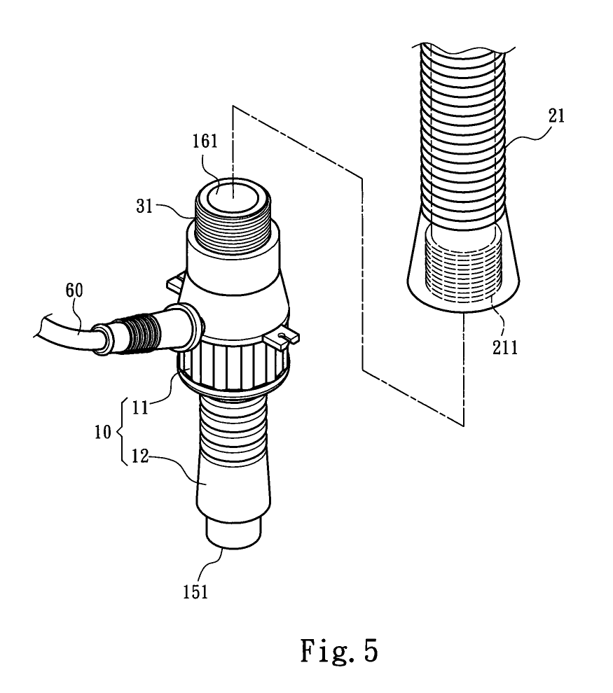

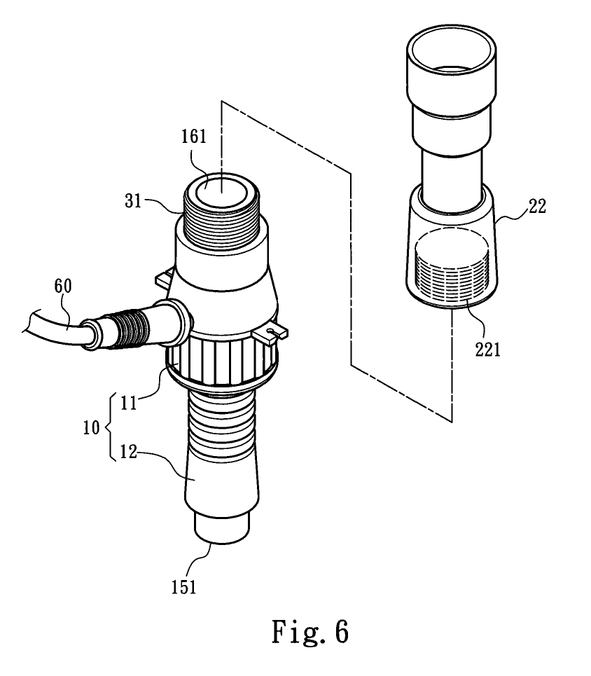

Please refer to FIGS. 1, 2 and 3, the present invention provides a hydraulic acne suction cleanser 100. It mainly includes a suction head 50 and a body 10, the body 10 is connected to an end connector 21 of a shower duct (also referring to FIG. 5) or an adapter duct 22 is coupled on an outlet of a faucet (referring to FIG. 6), and a connection hose 60 communicating with the suction head 50 and the body 10. The end connector 21 of the shower duct and the adapter duct 22 have respectively internal threads 211 and 221 formed on the inner circumference thereof. To facilitate fabrication, the body 10 shown in the drawings consists of a first shell 11 and a second shell 12 coupling together. However, this is not the limitation of the present invention. The first and second shells 11 and 12 may also be coupled by bonding or seamless coupling to become one piece. The object is to form a stronger structure for the body 10 and also make production simpler. The body 10 has a closed pressurized chamber 13 with a suction port 14 formed thereon to communicate the pressurized chamber 13 and the exterior space of the body 10. As shown in the drawings, the suction port 14 can be connected to the suction head 50 through the connection hose 60. The suction head 50 usually has a suction opening to suck acnes, or a suction means to generate suction airflow through the suction port 14 that is widely used in medical instruments. The body 10 further has a water discharge passage 15 and a water intake passage 16. The water discharge passage 15 is located in the body 10 and has a water outlet 151 at one end communicating to the exterior space of the body 10 and the other end formed a converging orifice 152 extended into the pressurized chamber 13. The suction port 14 has an opening directing towards the circumference of the converging orifice 152. The water intake passage 16 also is located in the body 10 and has one end communicating to the exterior space of the body 10 to form a water inlet 161 to connect to an external water supply end and the other end extended to form an ejection orifice 162 held in the pressurized chamber 13 and surrounded by the converging orifice 152. The ejection orifice 162 includes a nozzle 163 extended from the water intake passage 16 to the pressurized chamber 13 and an ejection duct 164 connecting to the opening of the nozzle 163. The nozzle 163 aims to center the pressure of flowing water in a gradually shrinking structure and send the centered water to the ejection duct 164 to be ejected out. The water inlet 161 is screwed with the internal threads 211 of the end connector 21 (referring to FIG. 5) or the internal threads 221 of the adapter duct 22 (referring to FIG. 6). Thus forms the fundamental structure of the present invention. As shown in FIG. 2, the water intake passage 16, pressurized chamber 13 and water discharge passage 15 in the body 10 are coupled together through the structure previously discussed to form a communicating space and flowing path to allow the water to pass through the body 10.

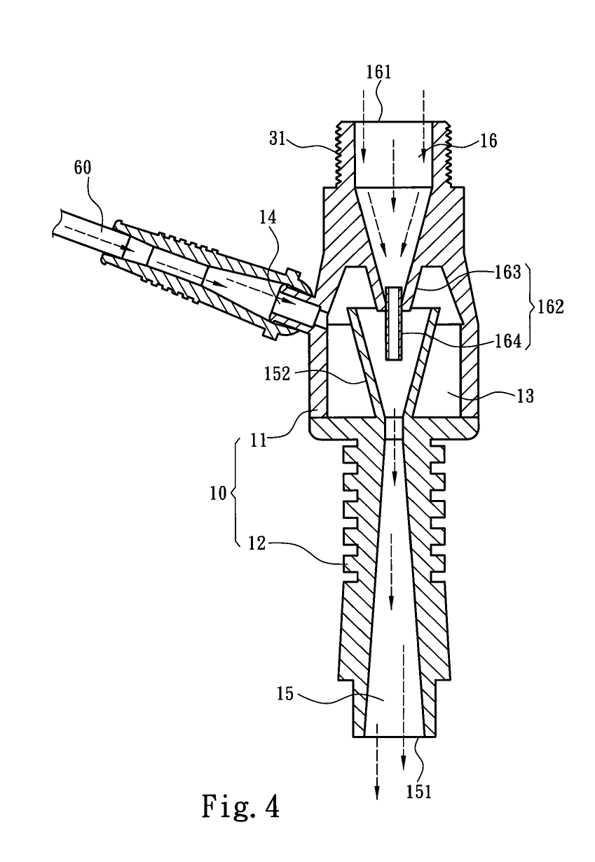

Referring to FIG. 4, when in use to channel water flow and suck airflow, the water inlet 161 is connected to the external water supply to receive water into the water intake passage 16; then the water flow passes through the ejection orifice 162 into the pressurized chamber 13, and passes through the converging orifice 152 into the water discharge passage 15 to be ejected out through the water outlet 151. While the water flow is ejected through the ejection orifice 162 into the pressurized chamber 13, a water pressure difference is generated to form an ejection pressure in the pressurized chamber 13, and a negative pressure is formed in the pressurized chamber 13 to suck in external airflow through the suction port 14 to mix with the water in the pressurized chamber 13; then the mixed water and air flow through the converging orifice 152 to the water discharge passage 15; finally, the mixed water and air are discharged through the water outlet 151. Namely, the water flow passes through the water inlet 161, water intake passage 16, ejection orifice 162, pressurized chamber 13, converging orifice 152, water discharge passage 15 and water outlet 151 to generate suction in the suction port 14. This is the operation principle of generating suction through water flow pressure employed in the present invention.

Refer to FIG. 5 for embodiment-1 of the present invention. The body 10 is connected to the end connector 21 of the shower duct, but it is not the limitation of the present invention. FIG. 6 illustrates embodiment-2 of the present invention in which the body 10 is connected to an adapter duct 22 of the outlet of a faucet. The water inlet 161 and the end connector 21 and adapter duct 22 are coupled together by screwing as shown in the drawings. The water inlet 161 has external threads 31 formed on the outer circumference to be screwed with the internal threads 211 and 221 on the inner circumferences of the end connector 21 and adapter duct 22. However, this is also not the limitation of the present invention. The locations of the internal threads 211 and 221 and external threads 31 may be switched, namely the internal threads 211 and 221 formed on the inner circumference of the water inlet 161 while the corresponding external threads 31 are formed on the outer circumferences of the end connector 21 and adapter duct 22. They all aim to provide tight coupling of the body 10 and external water supply end without loosening off under the variations of the water flow pressure. Such a screwing approach enables the body 10 of the present invention widely adapted in varying environments equipped with a water supply end that has internal threads 211 and 221 or external threads 31.

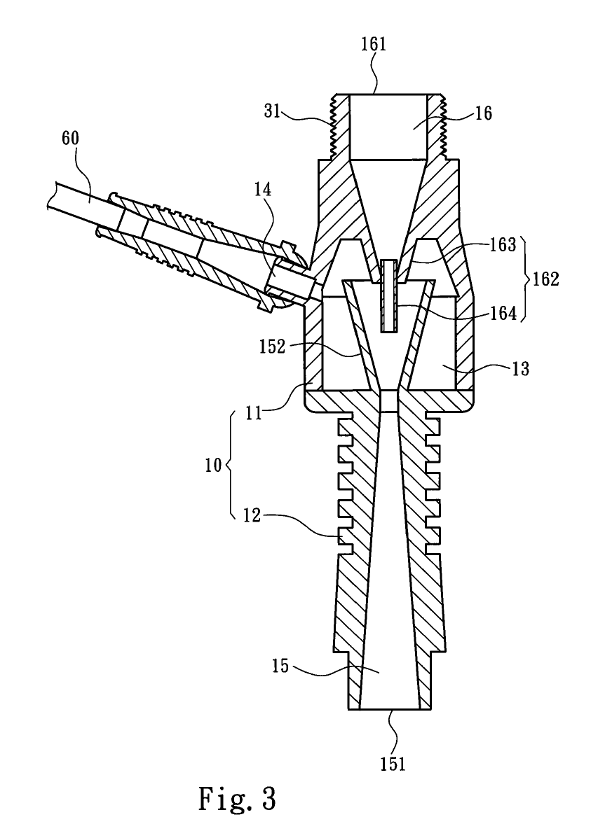

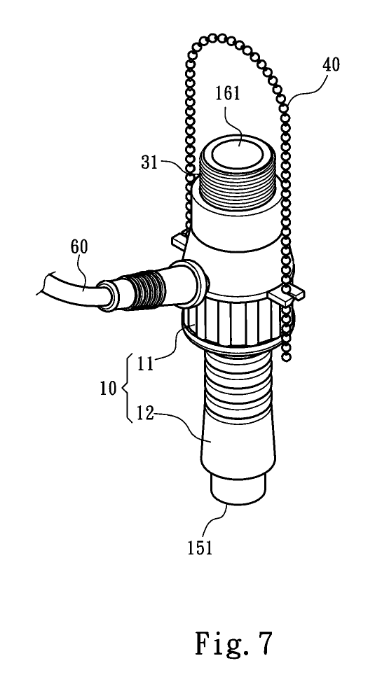

When the present invention is in use to connect to the end connector 21 of the shower duct, with the end connector 21 being a distal end of a pliable water hose, to prevent irregular shaking and swaying under water pressure after the body 10 is connected to the end connector 21, embodiment-3 shown in FIG. 7 may be adopted based on the one depicted in FIG. 3. The body 10 has a fixed chain 40 to hang or fasten the body 10 on a selected location when in use. Thus whether the body 10 is connected to the end connector of the pliable hose, the irregular shaking or swaying caused by water pressure can be prevented, and a steadier positioning of the present invention can be accomplished. Usability of the present invention can be further improved.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A hydraulic acne suction cleanser, comprising a suction head, a body connecting to an end connector of a shower duct or an adapter duct of an outlet of a faucet and a connection hose communicating the suction head and the body, the end connector and the adapter duct comprising respectively internal threads formed on an inner circumference thereof, the body including:
a closed pressurized chamber formed therein;
a suction port communicating the pressurized chamber and the exterior space of the body;
a water discharge passage which is located in the body and includes one end communicating to the exterior space of the body to form a water outlet and the other end extended into the pressurized chamber to form a converging orifice, the suction port with an opening directing towards the outer circumference of the converging orifice; and
a water intake passage which is located in the body and including one end communicating to the exterior space of the body to form a water inlet and the other end extended into the pressurized chamber to form an ejection orifice surrounded by the converging orifice, the water inlet comprising external threads on the outer circumference corresponding to the internal threads of the end connector or the adapter duct.

2. The hydraulic acne suction cleanser of claim 1, wherein the body further includes a fixed chain for positioning.

3. The hydraulic acne suction cleanser of claim 1, wherein the ejection orifice includes a nozzle extended from the water intake passage to the pressurized chamber and an ejection duct connecting to an opening of the nozzle.
